(19) United States
(12) Patent Application Publication
(10) Pub. No.: US 2023/0219299 A1
(43) Pub. Date: Jul. 13, 2023

(54) ADAPTIVE TOOLPATH FOR PRODUCING MATERIAL EXTRUSION 3D PRINTED MECHANICAL TESTING SPECIMENS

(71) Applicant: ESSENTIUM INC., Pflugerville, TX (US)

(72) Inventors: Thomas Mulholland, Austin, TX (US); Charles Brandon Sweeney, Pflugerville, TX (US); Bryan Zahner, Pflugerville, TX (US); Joseph Gerringer, Austin, TX (US)

(21) Appl. No.: 18/001,162

(22) PCT Filed: Jun. 30, 2021
(86) PCT No.: PCT/US21/39841

§ 371 Date: Dec. 8, 2022

Related U.S. Application Data
(60) Provisional application No. 63/046,185, filed on Jun. 30, 2020.

(51) Int. Cl. B29C 64/393; B29C 48/18; B29C 48/92; B29C 64/118; B33Y 10/00; B33Y 50/02; B33Y 80/00

(52) U.S. Cl. CPC B29C 64/393; B29C 48/18; B29C 48/92; B29C 64/118; B33Y 10/00; B33Y 50/02; B33Y 80/00

(57) ABSTRACT

A method of producing XY mechanical test specimens uses material extrusion additive manufacturing. Toolpaths are generated which vary a width of individual beads from a first narrow width in a gage length to a second width greater than the first width in a test specimen grip region. The test specimens produced using additive manufacturing or 3D printing processes reduce a severity of stress concentrators that cause the specimens to fail in the gage length.

### CROSS-REFERENCE TO RELATED APPLICATIONS

The present disclosure claims the benefit of the filing date of U.S. Provisional Application No. 63/046,185 filed on Jun. 30, 2020, the teachings of which are incorporated herein by reference.

### FIELD

The present disclosure relates to systems and methods to produce tensile test bars for identifying material mechanical property data using material extrusion additive manufacturing processes.

### BACKGROUND

The statements in this section merely provide background information related to the present disclosure and may or may not constitute prior art.

Material extrusion additive manufacturing (ME-AM) produces parts with anisotropic mechanical properties. Therefore, these properties are tested in different directions to provide relevant and useful mechanical property data to part designers. Parts can be defined as having three principal directions: along the length of deposited beads (or roads) in the plane of a layer (the XY direction), across the width of deposited beads in the plane of a layer (the YX direction), and parallel to the length of the deposited beads and parallel to the direction in which layers are deposited (the ZX direction).

Test specimens made according to international standards for plastics in the American Society for Testing Materials (ASTM) D638, and International Organization for Standardization (ISO 527) recommend dogbone-shaped test specimens, with a thinner central region (the gage length) and a wider grip region. When known software is used to generate mechanical test specimens for XY direction testing, the software generates toolpaths with a constant width. There are several methods to produce a sample of this shape with ME-AM. These methods result in stress concentrators in the transition region between a gage length and a grip region. This commonly causes the test specimen to fail in the transition region.

ASTM D638 and ISO 527 require valid test specimens to fail in the gage length to consider the test successful and useable for reporting. XY tensile bars tend to fail at stress concentrators caused by imperfect filling of the bar. The gage length of the bar in the common case of ISO 527 Type 1 bars has a width of 10 mm, while the tab has a width of 20 mm. In the filleted transition region (delta region), there are gaps which cannot be filled using known slicing software. These gaps act as crack initiators and cause early failure in the tensile bars, lowering the reported tensile strength for the material. Because of this failure mode, many mechanical test specimens for the XY direction produced by ME-AM do not produce useable results according to the standards.

Thus, while the current systems and methods to generate mechanical test specimens for XY direction testing are useful for their intended purpose, there is room in the art for an improved system and method for producing material extrusion 3D printed mechanical testing specimens.

### SUMMARY

This disclosure describes a system and method for generating mechanical test specimens for XY direction testing. Test specimens are three-dimensional (3D) printed using extrusion based additive printing out of one or more thermoplastic materials. The 3D printed part or test specimen may include post-processing such as computer numerical control (CNC) machining to achieve Geometric Dimensioning and Tolerance (GD&T) standards according to the application.

The system and method of the present disclosure produces beads of extruded material having a width that is variable based on predetermined material feed speed and volumetric flow rate as well as material temperature.

The system and method of the present disclosure eliminates stress concentrators and discontinuities in a test bar by continuously varying (increasing) an extrusion width (path width) of individual beads as the beads extend from an initial width in a gage region of the test bar gradually expanding through a transition region and ending at a final width in a grip region of the test bar. Continuously varying the extrusion width eliminates gaps between the beads and precludes having incomplete beads of material in the test bar.

The system and method of the present disclosure may be initiated using computer code to create a test specimen or may be initiated using computer assisted design (CAD) software to create a test specimen.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic view of exemplary extruded beads of a section of a test bar using a system and method for producing material extrusion 3D printed mechanical testing specimens according to the principles of the present disclosure;

FIG. 2 is a cross-sectional end elevational view of an exemplary extruded bead of the present disclosure;

FIG. 3 is an elevational view of the bead adjusted bead widths of FIG. 3;

FIG. 4 is an elevational view of the bead adjusted bead heights of FIG. 4;

FIG. 5 is a top plan view of a test bar produced using the system and method of the present disclosure; and

FIG. 6 is a top plan view modified from FIG. 5 showing a prior art test bar produced using a known extrusion method.

### DETAILED DESCRIPTION

The following description is merely exemplary in nature and is not intended to limit the present disclosure, application, or uses.

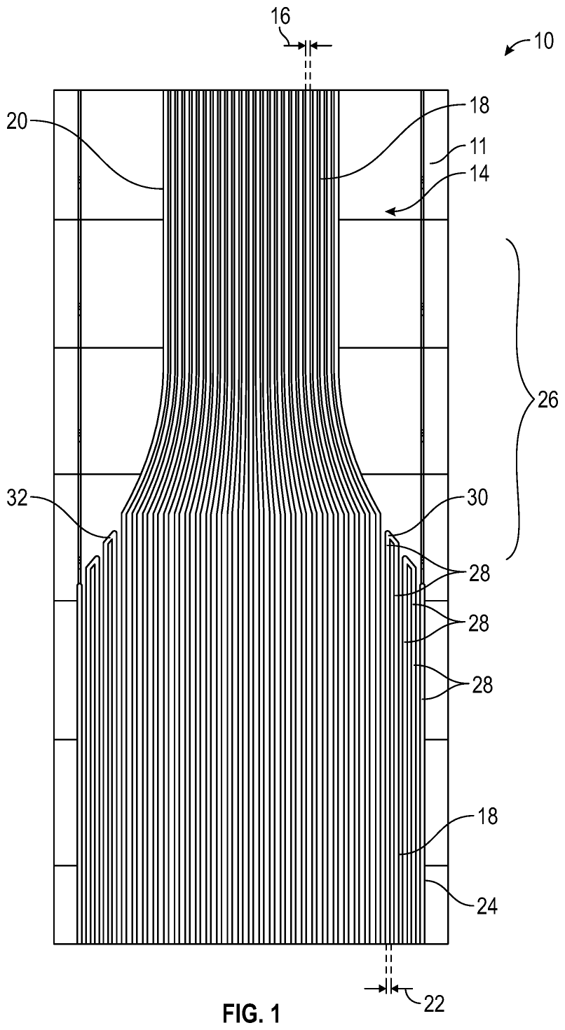

Referring now to FIG. 1, a system and method for producing material extrusion 3D printed mechanical testing specimens 10 includes nozzle 12, and in particular aspects includes a 0.4-mm opening diameter nozzle 12, for use on an ME-AM 3D printer used to create a test specimen or test bar 14. A programming script written for example in Python, Java, or another programming language is used to generate a toolpath, which toolpath, expressed in g-code or another programming language, is used by a 3D printer to print the test specimen. An exemplary case is presented using a 0.4-mm extrusion width 16 of individual extruded beads 18 of a polymeric material, provided to the nozzle e.g., in filament form, in a gage region 20, which in aspects is 60 mm in length, and a 0.6-mm extrusion width 22 of the extruded beads 18 in a tab or grip region 24 of the test bar 14, which in aspects is 21 mm in length. Note that while one grip region 24 is illustrated, in most aspects, a test bar 14 includes a grip region 24 at either end of the test bar 14. According to several aspects, a total of 25 complete extruded beads 18 are used to make the test bar 14, however this value can vary within the scope of the present disclosure. The system and method for producing material extrusion 3D printed mechanical testing specimens 10 eliminates stress concentrators and discontinuities in the test bar 14 by continuously varying (increasing) the extrusion width (path width) of individual beads 18 as the beads 18 extend from an initial width in the gage region 20 gradually expanding through a transition region 26 and ending at a final width in the grip region 24 of the test bar 14.

The toolpaths vary the width of the bead 18 from the thinner 0.4-mm extrusion width 16 in the gage region 20 to the thicker or wider 0.6-mm extrusion width 22 in the grip region 24 by continuously increasing the width in the transition region 26 between the gage region 20 and the grip region 24. In aspects, each transition region is in the range of 24 mm in length. This allows production of test specimens that reduce a severity of stress concentrators that are known to cause the specimens to fail in the transition region 26 such that test failure will occur in the gage region 20 as desired. The present system and method mimics the way injection molded specimens are prepared. The flow fields that form when molten polymer is injected into a dogbone-shaped cavity cause the polymer flow front to “neck down” as it enters the gage region 20, then flair out or swell in width as it fills toward the other end at the grip region 24. In the gage region 20 all of the beads 18 have a common initial width. Extending into the transition region 26 all of the beads have a generally increasing width of the beads 18, and in the grip region 24 all of the beads have a common final width wider than the initial width and wider than the widths in the transition region 26. While reference is made to an aspect utilizing a 0.4 mm diameter nozzle opening, a 0.4 thick bead width in a first, gage region and a 0.6 mm thick bead in a second, grip region, it should be appreciated that alternative dimensions may be utilized herein as well, provided that the overall dimensions determined by the testing standard are met. Thus, if a larger diameter nozzle is used, or thicker beads are used, fewer than 25 beads may be necessary. If a smaller diameter opening nozzle is used, or thinner beads are used, more than 25 beads may be necessary.

With continuing reference to FIG. 1, a preferred aspect would be to use the 0.4-mm extrusion width 16 throughout the gage region 20 and a 0.8-mm extrusion width in the tab or grip region 24, providing 25 total beads 18 to make the test bar 14. However, it has been determined that quality of extrusion at the 0.8-mm width may be reduced with some materials, lowering mechanical properties, therefore, in aspects, an extrusion width in the grip region 24 is set to 0.6 mm. Additional extruded beads 28 may then be added to an opposed first side 30 and a second side 32 of the grip region 24 to set a width of 20 mm in the grip region 24.

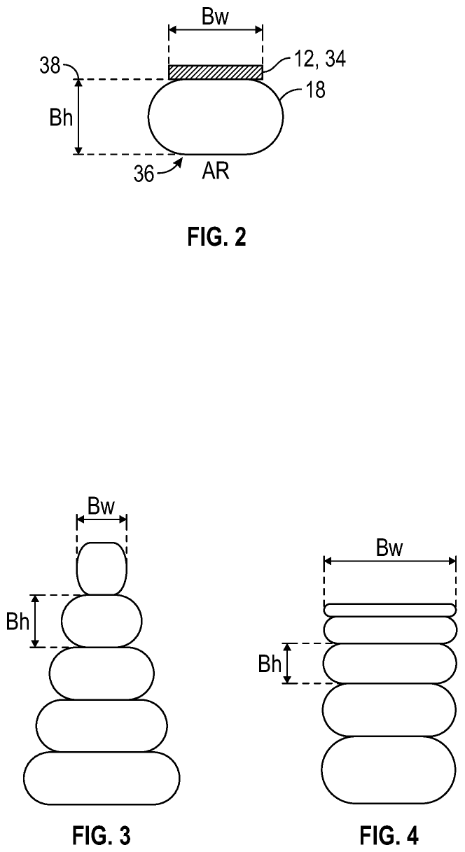

Referring to FIG. 2 and again to FIG. 1, the width of the bead 18 is normally the preferred variable dimension of the bead 18 for the following reasons. A tip 34 of the extrusion nozzle 12 through which material is being expressed acts to constrain the height of the bead 38 as the tip 34 limits an upper surface position of the bead 18. A lower surface 36 of the bead 18 is constrained by addition of extrusion material onto either a build plate 11 as the initial material layer or by extrusion onto a previously extruded bead layer below the newly expressed bead 18, therefore the extrusion nozzle tip 34 and material at the bead lower surface 36 together limit a height 38 of the bead 18. The width of the bead 18 at any position along the bead 18, such as the extrusion width 16 in the gage region 20 or the extrusion width 22 in the grip region 24 is variable by selectively altering an extrusion velocity and a volume flow rate of material through the nozzle 12 using the programmed instructions of the system and method for producing material extrusion 3D printed mechanical testing specimens 10.

During preparation of the toolpaths common print parameters are adjusted, including an extrusion or aspect ratio AR defined as the bead width divided by the bead height 38, a material extrusion temperature, and parameters of an acceleration compensation factor to account for acceleration of the nozzle 12 during printing. A print speed may be adjusted dynamically to keep a constant polymer volumetric flow rate. The constant volumetric flow rate allows the extruded material to have the same residence time in the nozzle 12 and have approximately the same deposition temperature. The constant extrusion speed allows the extrusion material to have the same residence time in the nozzle 12 and have approximately the same deposition temperature. Thus, the residence time in the nozzle is maintained the same at a first extrusion speed in the first, gage 20 region and at a second extrusion speed in the second, grip 24 region.

Referring to FIG. 3, if the layer height, or bead height Bh, is maintained constant the bead width, Bw, is adjustable. For example, if the layer height, or bead height Bh, is predetermined and fixed at 0.2 mm, the bead width Bw can be adjusted to a predetermined width. FIG. 3 illustrates multiple exemplary bead widths and relative aspects ratios AR, bead width Bw to bead height Bh, of 2:2, 3:2, 4:2, 5:2, and 6:2 top to bottom.

Referring to FIG. 4, if the bead width Bw is maintained constant the bead height Bh is adjustable. For example, if the layer or bead width Bw is predetermined and fixed at 0.4 mm, the bead height Bh can be adjusted to a predetermined height. FIG. 4 illustrates multiple exemplary bead heights and relative aspects ratios AR, bead width Bw to bead height Bh, of 10:1, 10:2, 10:3, 10:4, and 10:5 top to bottom.

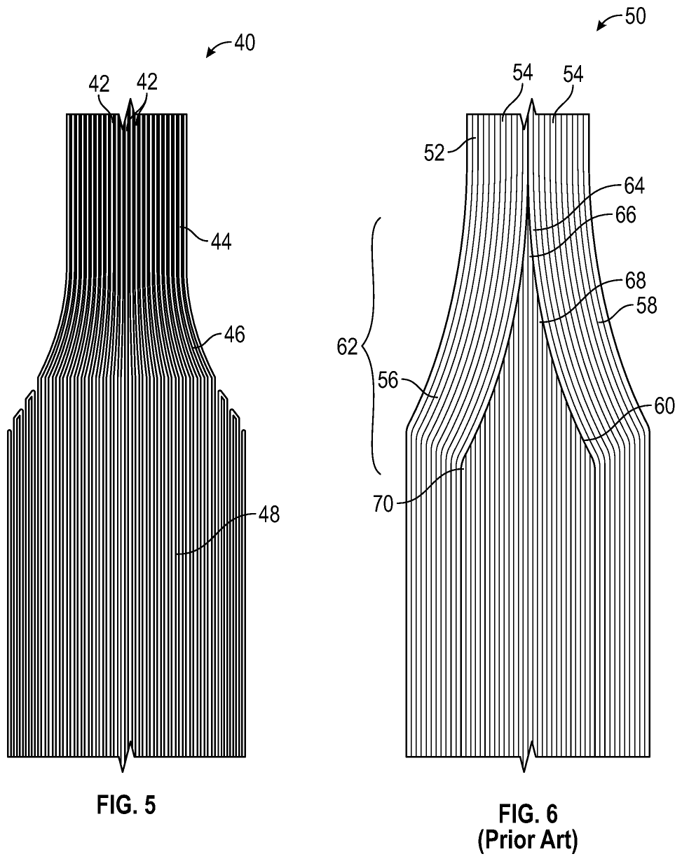

Referring to FIG. 5, an exemplary test bar 40 extruded using the system and method for producing material extrusion 3D printed mechanical testing specimens 10 described above provides a common quantity of extruded beads 42 throughout a gage region 44 and a transition region 46, with the extruded beads 42 widening through the transition region 46 into a grip region 48. No discontinuities of the extruded beads 42 are present in either the gage region 44 or the transition region 46.

Referring to FIG. 6 and again to FIG. 5, a test bar 50 made using a known method having a common width of extruded beads throughout provides a gage region 52 having multiple extruded beads 54 which bifurcates into a first partial group of beads 56 and a second partial group of beads 58 at the location of a transition bead group 60 in a transition region 62. The number of beads in the partial bead groups 56, 58 may be in the range of 9 to 13. Multiple cavities 64, 66, 68, 70 are created by the inclusion of the transition region 62 of the transition bead group 60. These cavities 64, 66, 68, 70 define discontinuities which are known to cause failure of the test bar 50 at or near the transition region 62, in contrast to the test bar 40 presented in FIG. 5. Such failures alter the testing results producing relatively lower testing data than expected.

A comparative analysis was performed of tensile testing bars produced using continuous varying bead width as described herein and illustrated in FIG. 5 and the bifurcated gage with infill as illustrated in FIG. 6. Six specimens of each configuration were printed in a polyamide filament including carbon fiber material (PA-CF, available from ESSENTIUM, Pflugerville, Tex.) using Simplify3D printing software. The samples were printed at an extrusion speed of 150 mm/s, with a 0.4 mm extrusion width, 0.2 mm layer height) at a nozzle temperature of 350° C. onto a GAROLITE G7 print bed maintained at 60° C. Specimens were conditioned for 16 hours at 60° C. and tested at 5 mm/min on a universal testing system in the dried condition. Nearly all the specimens printed using the bifurcated gage broke in the transition region, whereas only one specimen produced using the continuous varying bead width described herein broke in the transition region, whereas the remaining five broke in the gage region. Overall, the bars printed in accordance with the present disclosure using the continuous varying bead width demonstrated a 4.5% (p-value: 0%) improvement in ultimate tensile strength, an increase of 47.7% (p-value: 0%) in tensile modulus, and a statistically insignificant decrease in tensile modulus (p-value: 82%). Further, the coefficient of various for strain at bread was at 4.3% for the bars produced using the continuous varying bead width.

According to other aspects, a method of continuously varying an extrusion width (path width) through a transition region between a gage length and a grip region of a test specimen 10 is provided. According to several aspects, the method utilizes computer code, such as a program written in Python, Java, or another programming language to algorithmically generate toolpaths. The program uses known dimensions of a standardized test specimen and calculates coordinates and material deposition amounts. The program produces a toolpath file, generally as G-code, for use on an ME-AM 3D printer.

According to further aspects an operator writes toolpath instructions (generally utilizing G-code) directly, utilizing known dimensions of the standardized test specimen and calculating the coordinates and material deposition amounts.

According to several aspects the functionality of printing standardized test specimens is incorporated into computer software. The designer of the software creates an algorithm allowing the toolpath width to be adjusted according to predetermined criteria; for example, the algorithm eliminates gaps between toolpaths by adjusting the toolpath width according to a predetermined physical range.

According to several aspects the functionality of allowing several variable extrusion width beads in each layer of a part is incorporated into computer software. The designer of the software creates an algorithm allowing the toolpath width to be adjusted according to predetermined criteria; for example, the algorithm allows all beads placed on a perimeter of an object in a predetermined layer to have an equal width, different from a default width used in other areas of a part. The equal width beads eliminate gaps between toolpaths by adjusting the toolpath width according to a predetermined physical range.

The method of the present disclosure moves discontinuities outside of the gage length and outside the shoulder region of the tensile bar. The failure stress is thereby increased. By continuously varying the extrusion width while traveling from the gage to the tab regions, the delta region is eliminated.

The method of the present disclosure produces XY mechanical test specimens using ME-AM.

The method provided herein artificially mimics the flow fields produced from injection molded specimens with the flared toolpath and modulated bead width. This results in an optimized strain field in the transition region which leads to higher quality test data and is more representative of the true mechanical properties of the material.

A method for producing tensile test bars by material extrusion additive manufacturing (ME-AM) of the present disclosure produces tensile test bars which avoid stress concentrators.

Accordingly, several aspects of the present disclosure relate to a 3D printed specimen. The 3D printed specimen includes a plurality of beads, wherein the plurality of beads define a first region and a second region. The first region exhibits a first region width, and the second region exhibits a second region width, wherein the first region width is less than the second region width. Each of said plurality of beads exhibit a first bead dimension in the first region and a second bead dimension in the second region. The first bead dimension and the second bead dimension are both one of a width and a height. In particular aspects, the 3D printed specimen is a dogbone for mechanical testing and, in particular, for tensile testing.

In aspects of the above, the first bead dimension is a first bead width, and the second bead dimension is a second bead width.

In any of the above aspects, the second region includes a first additional set of beads disposed on a first side of the plurality of beads and a second additional set of beads disposed on a second side of the plurality of beads opposing the first set of beads.

In any of the above aspects, the specimen is in the shape of a dog bone and wherein the first region forms a gage region, and the second region forms a grip region.

In any of the above aspects, the 3D printed test specimen further includes a transition region between the first region and the second region and in the transition region the plurality of beads each transition between the first bead width and the second bead width.

In any of the above aspects, the first bead width is 0.4 mm, and the second width is 0.6 mm.

In any of the above aspects, there are twenty five beads in the plurality of beads.

In any of the above aspects, no discontinuities are present in each of the plurality of beads in the first region and the second region.

Additional aspects of the present disclosure relate to a method of forming a specimen, including any of the aspects of the specimen described above. The method includes extruding a plurality of beads from a nozzle; and forming a first region and a second region with the plurality of beads. Each of said plurality of beads exhibit a first bead dimension in the first region and a second bead dimension in the second region. Further, the first region exhibits a first region width, and the second region exhibits a second region width, and the first region width is less than the second region width, and the first bead dimension and the second bead dimension are one of a width and a height.

In any of the above aspects, the first dimension is a first bead width, and the second bead dimension is a second bead width.

In any of the above aspects, the second bead width is greater than an opening diameter of the nozzle.

In any of the above aspects, the method further includes extruding a transition region between the first region and the second region and in the transition region the plurality of beads each transition between the first bead width and the second bead width.

In any of the above aspects, the method further includes increasing the width of the second region by extruding a first additional set of beads adjacent to a first side of the plurality of beads in the second region; and extruding a second additional set of beads adjacent to a second side of the plurality of beads, wherein the first side opposes the second side.

In any of the above aspects, the method further includes varying at least one of an extrusion speed and a volumetric flow rate while forming the first region and the second region.

In aspects of the above, a residence time in the nozzle is maintained the same at the first speed and at the second speed.

In aspects of the above, a deposition temperature of the plurality of beads is maintained the same in the first region and the second region.

In any of the above aspects, the method further includes generating a tool path for extruding the plurality of beads.

In any of the above aspects, the method further includes constraining the height of the plurality of beads between the nozzle and one of a build plate supporting the plurality of beads or a previously extruded bead.

Yet further aspects of the present disclosure relate to system for forming a specimen. The system includes a three-dimensional printer including an extrusion nozzle, wherein the three-dimensional printer is configured to extrude a plurality of beads along a tool path; and a programming script configured for use by the three-dimensional printer, the programming script including instructions defining the tool path, wherein the tool path defines the plurality of beads, wherein the plurality of beads define a first region and a second region and each of said plurality of beads exhibit a first bead dimension in the first region and a second bead dimension in the second region, wherein the first region exhibits a first region width and the second region exhibits a second region width and the first region width is less than the second region width and the first bead dimension and the second bead dimension are both one of a width and a height.

Advantages of the present 3D printed specimen, system, and method include, but are not limited to, a reduction in discontinuities along the bead length reducing stress concentrations that may cause failure of the test specimen, particularly in the gage length and transition region. Further advantages include mimicking the preparation of injection molded test specimens through the 3D printing method, including necking down of the flow front in the gage region and flaring out of the flow front in the grip region.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A 3D printed specimen, comprising:
a plurality of beads, wherein the plurality of beads define a first region and a second region and each of the plurality of beads exhibit a first bead dimension in the first region and a second bead dimension in the second region, wherein the first region exhibits a first region width and the second region exhibits a second region width and the first region width is less than the second region width, and the first bead dimension and the second bead dimension are both one of a width and a height.

2. The 3D printed specimen of claim 1, wherein the second region includes a first additional set of beads disposed on a first side of the plurality of beads and a second additional set of beads disposed on a second side of the plurality of beads opposing the first additional set of beads.

3. The 3D printed specimen of claim 2, wherein the specimen is in a shape of a dogbone and wherein the first region forms a gage region, and the second region forms a grip region.

4. The 3D printed specimen of claim 1, wherein the first bead dimension is a first bead width and the second bead dimension is a second bead width.

5. The 3D printed specimen of claim 4, further comprising a transition region between the first region and the second region and in the transition region the plurality of beads each transition between the first bead width and the second bead width.

6. The 3D printed specimen of claim 4, wherein the first bead width is 0.4 mm and the second bead width is 0.6 mm.

7. The 3D printed specimen of claim 4, wherein there are twenty five beads in the plurality of beads.

8. The 3D printed specimen of claim 1, wherein no discontinuities are present in each of the plurality of beads in the first region and the second region.

9. A method of forming a specimen, comprising:
extruding a plurality of beads from a nozzle; and
forming a first region and a second region with the plurality of beads, wherein each of said plurality of beads exhibit a first bead dimension in the first region and a second bead dimension in the second region, wherein the first region exhibits a first region width and the second region exhibits a second region width, and the first region width is less than the second region width, and the first bead dimension and the second bead dimension are one of a width and a height.

10. The method of claim 9, wherein the first bead dimension is a first bead width and the second bead dimension is a second bead width.

11. The method of claim 10, wherein the second bead width is greater than an opening diameter of the nozzle.

12. The method of claim 11, further comprising extruding a transition region between the first region and the second region and in the transition region the plurality of beads each transition between the first bead width and the second bead width.

13. The method of claim 10, further comprising increasing the width of the second region by extruding a first additional set of beads adjacent to a first side of the plurality of beads in the second region; and extruding a second additional set of beads adjacent to a second side of the plurality of beads, wherein the first side opposes the second side.

14. The method of claim 10, further comprising varying at least one of an extrusion speed and a volumetric flow rate while forming the first region and the second region.

15. The method of claim 14, wherein a residence time in the nozzle is maintained the same at a first extrusion speed in the first region and at a second extrusion speed in the second region.

16. The method of claim 14, wherein a deposition temperature of the plurality of beads is maintained the same in the first region and the second region.

17. The method of claim 10, further comprising generating a tool path for extruding the plurality of beads.

18. The method of claim 10, further comprising constraining the height of the plurality of beads between the nozzle and one of a build plate supporting the plurality of beads or a previously extruded bead.

19. A system for forming a specimen, comprising:
a three-dimensional printer including an extrusion nozzle, wherein the three-dimensional printer is configured to extrude a plurality of beads along a tool path; and
a programming script configured for use by the three-dimensional printer, the programming script including instructions defining the tool path, wherein the tool path defines the plurality of beads, wherein the plurality of beads define a first region and a second region and each of said plurality of beads exhibit a first bead dimension in the first region and a second bead dimension in the second region, wherein the first region exhibits a first region width and the second region exhibits a second region width and the first region width is less than the second region width, and the first bead dimension and the second bead dimension are both one of a width and a height.
